(19) United States
(12) Patent Application Publication
(10) Pub. No.: US 2026/0148348 A1
(43) Pub. Date: May 28, 2026

(54) AUGMENTING PERCEPTUAL SUPER-RESOLUTION VIA IMAGE QUALITY PREDICTORS

(71) Applicant: SAMSUNG ELECTRONICS CO., LTD., Suwon-si (KR)

(72) Inventors: Fengjia ZHANG, Toronto (CA); Samrudhdhi Bharatkumar RANGREJ, Toronto (CA); Tristan Ty AUMENTADO-ARMSTRONG, Toronto (CA); Afsaneh FAZLY, Aurora (CA); Aleksai LEVINSHTEIN, Thornhill (CA)

(21) Appl. No.: 19/384,270

(22) Filed: Nov. 10, 2025

Related U.S. Application Data
(60) Provisional application No. 63/725,398, filed on Nov. 26, 2024.

(51) Int. Cl. G06T 5/60; G06T 3/4046

(52) U.S. Cl. CPC G06T 5/60; G06T 3/4046

(57) ABSTRACT

A method performed by at least one processor in an electronic apparatus includes receiving an input image having a first resolution; inputting the input image with the first resolution into an image enhancement model to generate an output image having a second resolution higher than the first resolution; inputting a plurality of ground truth images into an image quality assessment model to generate ground truth image scores for the plurality of ground-truth images, each of the plurality of ground truth images having a third resolution; selecting a ground truth image from the plurality of ground truth images based on the generated ground truth image scores; determining a reference loss between the output image and the selected ground truth image; and training the image enhancement model based on the reference loss.

### CROSS-REFERENCE TO RELATED APPLICATION

This application claims the benefit of U.S. provisional application No. 63/725,398 filed on Nov. 26, 2024, the entire contents of which are incorporated herein by reference.

### BACKGROUND

### 1. Field

This disclosure is directed to augmenting perceptual super-resolution images via image quality predictors.

### 2. Related Art

Super-resolution (SR), a classical inverse problem in computer vision, is inherently ill-posed, inducing a distribution of plausible solutions for every input. However, the desired result is not simply the expectation of this distribution, which is the blurry image obtained by minimizing pixelwise error, but rather the sample with the highest image quality.

Conventional NR-IQA models predict image quality by learning on datasets of human preferences. The input is an image, and the output is a single scalar score, relating to absolute image quality. Existing models can operate on any image, but are not specialized for image restoration (IR) or super-resolution (SR) and are only used for evaluation, not in the algorithm itself.

Conventional models are implemented as neural networks (e.g., MUSIQ), meaning they are differentiable, and could in theory be used to train SR or IR methods.

Conventional SR and IR algorithms are trained with paired data: one low-quality (LQ) image (input) and one high-quality (HQ) image (output). The model learns to map LQ images to HQ ones. However, there are usually many possible HQ images corresponding to a given LQ input. For example, consider a very blurry image. The underlying true details could be of many possible forms. In Computer Vision parlance, the solution space is multimodal. Conventional methods are unable to distinguish between different potential HQ images when training, and ignore this problem by simply using a single one, which is usually the “original” HQ image(s).

The Human Guided Ground-Truth method trains an SR algorithm while considering a few possible HQ images per LQ input. In this regard, this method runs existing SR models on the original HQ, and have humans judge which HQ outputs are best. The training algorithm then only uses the images judged better via gathered human data. However, (i) gathering human data is time-consuming and expensive, and therefore not scalable, and (ii) this mechanism cannot be directly optimized.

### SUMMARY

According to an aspect of the disclosure, a method performed by at least one processor in an electronic apparatus includes receiving an input image having a first resolution; inputting the input image with the first resolution into an image enhancement model to generate an output image having a second resolution higher than the first resolution; inputting a plurality of ground truth images into an image quality assessment model to generate ground truth image scores for the plurality of ground-truth images, each of the plurality of ground truth images having a third resolution; selecting a ground truth image from the plurality of ground truth images based on the generated ground truth image scores; determining a reference loss between the output image and the selected ground truth image; and training the image enhancement model based on the reference loss.

According to an aspect of the disclosure, a method performed by at least one processor in an electronic apparatus includes receiving an input image having a first resolution; inputting the input image with the first resolution into an image enhancement model to generate an output image having a second resolution higher than the first resolution; inputting the output image into the image quality assessment model to obtain a reference free loss score; and training the image enhancement model based on the reference free loss score.

According to an aspect of the disclosure, an electronic apparatus includes: a memory storing one or more instructions; at least one processor operatively coupled to the memory, in which, the one or more instructions, when executed by the at least one processor, cause the electronic apparatus to: receive an input image having a first resolution, input the input image with the first resolution into an image enhancement model to generate an output image having a second resolution higher than the first resolution, input a plurality of ground truth images into an image quality assessment model to generate ground truth image scores for the plurality of ground-truth images, each of the plurality of ground truth images having a third resolution, select a ground truth image from the plurality of ground truth images based on the generated ground truth image scores, determine a reference loss between the output image and the selected ground truth image, and train the image enhancement model based on the reference loss.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates a flowchart for inference and training, in accordance with embodiments of the present disclosure.

FIG. 4 illustrates a flowchart of an example non-reference image quality assessment (NR-IQA) based sampling process for training a super-resolution image restoration (SR/IR) neural model, in accordance with embodiments of the present disclosure.

FIG. 5 illustrates an example ground truth selection process, in accordance with embodiments of the present disclosure.

FIG. 6 illustrates an example ground truth selection process, in accordance with embodiments of the present disclosure.

FIG. 7 illustrates an example NR-IQA based sampling and direct optimization process for training a SR/IR neural model, in accordance with embodiments of the present disclosure.

FIG. 8 illustrates a method for training part of a network using low-rank adaptation (LoRA), in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

The embodiments are directed to using non-reference image quality assessment (NR-IQA) models in the super-resolution (SR) context. The embodiments include two methods of applying NR-IQA models to SR including: (i) altering data sampling, by building on an existing multi-ground-truth SR framework, and (ii) directly optimizing a differentiable quality score.

The embodiments of the present disclosure advantageously apply NR-IQA models to the training of SR/IR models including altering sampling for multimodal training and direct optimization (e.g., NR-IQA itself as a differentiable objective).

The embodiments of the present disclosure, compared to human scores, are advantageously (i) faster and more scalable, (ii) more fine-grained (e.g., can provide a continuous score instead of a single ranking), and (iii) can be applied dynamically to arbitrary patches.

The embodiments of the present disclosure advantageously utilize a neural NR-IQA model as a loss function.

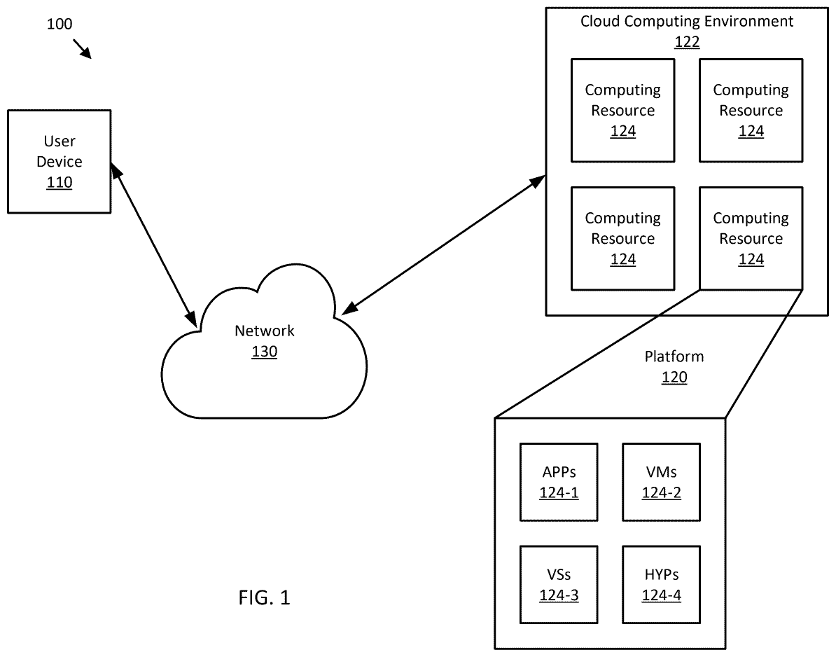

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

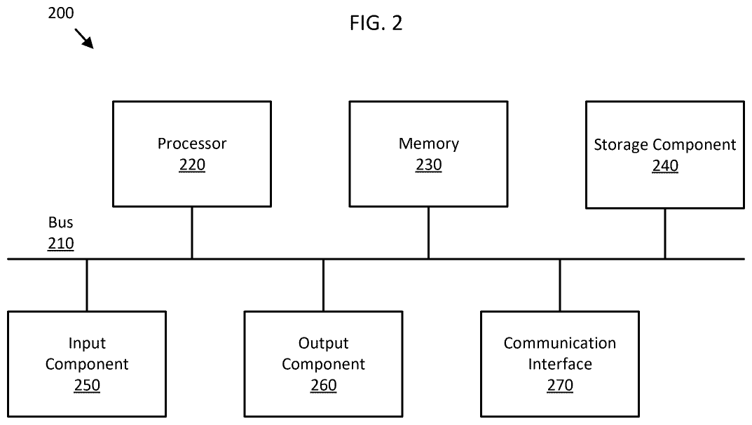

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the device 200 may be a controller of a smart home system that communicates with one or more sensors, cameras, smart home appliances, and/or autonomous robots. The device 200 may communicate with the cloud computing environment 122 to offload one or more tasks.

Many tasks in human and computer vision are naturally formulated as ill-posed inverse problems. Single-image super-resolution (SISR), which has many practical applications to digital photographic zoom, is a well-studied example of this. In SISR, a given low-resolution (LR) image has an associated distribution of high-resolution (HR) “real” images that could have given rise to it. Furthermore, many images may have other types of degradations such as blur, noise, various color artifacts. The fundamental challenge of SR is therefore not just to find any sample from that distribution, but instead, to find perceptually plausible one(s). Early learning-based models, trained with pixel-wise losses, effectively “average” over possible solutions in pixel-space, resulting in blurry output images with a high peak signal-to-noise ratio (PSNR). However, human preferences indicate a solution with high image quality is better than an image with averaged quality. As a result, numerous techniques have been devised to emphasize perceptual fidelity, such as perceptual metrics and adversarial losses, greatly improving image quality. For example, pixelwise fidelity is a poor measure of perceptual quality. In fact, under some conditions, they are directly oppositional, forming a “perception-distortion tradeoff”. In theory, the only pixel-space constraint is given by the LR image. The optimal SR result (in terms of human preference) may have very high pixelwise distortion (to the “real” ground-truth generating image), as long as it has high plausibility with respect to the LR input and high image quality.

Thus, rather than optimizing pixel-space distortions, perceptual image quality may be improved instead. This is commonly done using a combination of perceptual losses and GANs, which enables the model to target a multi-modal distribution rather than specific ground-truth targets. The challenge of such methods, however, is to produce perceptually plausible outputs without introducing high-frequency artifacts. Many full-reference (FR) and NR-IQA metrics were developed to align with human preferences for identifying perceptually plausible images. While some approaches replace perceptual losses (e.g., LPIPS and DISTS) with FR metrics, for the task of image restoration, NR-IQA metrics are still used purely for evaluation purposes. However, similar to the way human feedback guidance is used in text-to-image generative models, the embodiments of the present disclosure advantageously use NR-IQA metrics to improve SISR.

Existing works use human feedback to improve SISR by generating multiple enhanced versions of GT images manually, rating these different versions using multiple human evaluators, and fine-tuning the model on the positively ranked GTs. This manual human ranking is very coarse and cumbersome.

According to the embodiments of the present disclosure, in the method proposed herein, automatic NR-IQA measure that is well-correlated with human scores is used instead of manual human scores, yielding both a more fine-grained ranking and bypassing the requirement for having human feedback. Additionally, as the measure is fully differentiable, it can be used as a direct optimization loss as a replacement or complement to GANs, unlike human scores that cannot be used in this fashion.

The embodiments of the present disclosure improve existing SR methods with an interest in perceptual quality and its use in multimodal SR. In HGGT, a set of ground-truth images is constructed per input, with varying quality, and human tests are used to rank their relative quality. In contrast, the embodiments include two methods of applying neural IQA models to augment ground-truth images: altering the choice of ground-truth set based on an automated IQA weight and directly optimizing the IQA model in a fine-tuning step.

The HGGT dataset includes (i) a set of images (“originals”), (ii) a set of four super-resolved versions of each original (“enhanced GTs”), and (iii) human annotations for each enhanced GT (“positive”, “similar”, or “negative” meaning better, indistinguishable, or worse than the original). The set of positives provides multimodal supervision, since each one is a disparate yet reasonable GT for learning (e.g., at least as good as the original GT image). The HGGT solutions show that utilizing these synthetic GTs may be used for SR training, exploring several neural architectures and degradation settings. While HGGT explores several variants for utilizing their human labels, there is a simple but highly performing “positives-only” scenario, which performs equivalently or better than the variants utilizing negatives. In this scenario, at each training iteration, every input image supervises the network with a GT chosen uniformly randomly from the positives. As is relatively standard in SR, HGGT models are trained with a combined loss:

$$ℒ ( θ \vert \hat{I} , I ) = {λ}_{{ℓ}_{1}} {‖ I - \hat{I} ‖}_{1} + {λ}_{P} {d}_{P} ( \hat{I} , I ) + {λ}_{A} D ( \hat{I} ) , \qquad Eq . ( 1 )$$

where Î=f_{θ}(I_{LQ}) is the SR estimate of the low-resolution (or low-quality) input I_{LQ}, via SR network f_{θ}, I˜ [symbol] [{I₁, . . . , Iₙ}] is the randomly chosen GT (from the set of positives corresponding to image I_{LQ}), d_{P} is a perceptual loss, and D is an adversarial discriminator.

However, HGGT requires human labels, which are difficult to scale and often domain-dependent. In contrast, neural NR-IQA models may be used because they do not require human labels, and also confer additional advantageous features including the ability to provide more fine-grained non-uniform sampling weights and to enable direct optimization.

There are alternatives to uniform sampling of the positives, based on an IQA model. For example, the following formulation may be considered:

$$I ∼ 𝒫 [ {S}_{I} \vert {SoftMax}_{T} ( Q ( {S}_{I} ) ) ] , \qquad Eq . ( 2 )$$

$$Q ( {S}_{I} ) = \{ Q ( {I}_{1} ) , … , Q ( {I}_{n} ) \} ,$$

$${S}_{I} = \{ {I}_{I} , … , {I}_{n} \} ∈ \{ {A}_{I} , {P}_{I} \}$$

where I is the sampled GT, T>0 is the softmax temperature, Q is the neural NR-IQA model (higher is better), [symbol] is a discrete probability distribution over elements of S_{I}, where S_{I} is the set of possible GTs (either choosing from all candidates, enhanced and original, denoted A_{I}, or positive ones, written P_{I}). The HGGT algorithm simply uses S_{I}=P_{I} and T→∞ (e.g., the uniform distribution). There are different combinations, including T→0 (e.g., the argmax choice). NR-IQA-based sampling can be more precise than uniform sampling. The following are three example NR-IQA-based sampling scenarios.

According to one or more embodiments, in a softmax-all (SMA) method, given a set of all GTs (e.g., S_{I}=A_{I}), an IQA-weighted distribution is used over GTs. This setting uses no human data, and simply randomly chooses a GT at each iteration with a weight proportional to softmax-rescaled quality. The parameter T may be set to ensure a distribution between uniform and Kronecker delta (e.g., argmax).

According to one or more embodiments, in a softmax-positives (SMP) method, this approach builds on the human data in HGGT, using the softmax-normalized IQA scores but only of the positives (e.g., S_{I}=P_{I}). This setting is the most similar to the HGGT positives-only (or uniform distribution on positives), just with non-uniform weights (based on T). As understood by one of ordinary skill in the art, the embodiments are not limited to obtaining weights from a softmax function. For example, any suitable method of obtaining a valid discrete probability mass function may be used.

According to one or more embodiments, in an argmax-online (AMO) method, the use of a neural IQA model confers an additional capability that human data lacks: dynamically determining sampling weights for new patches at training time. In particular, at every iteration, a patch may be sampled from the GT images (as normal), but from every potential GT. The parameter Q may be run on each patch, and the best one is selected (e.g., the argmax of Q values, so T→0). Human data is not used; hence, S_{I}=A_{I}. This enables a more fine-grained judgment, whereas human annotations are not as easily extrapolated.

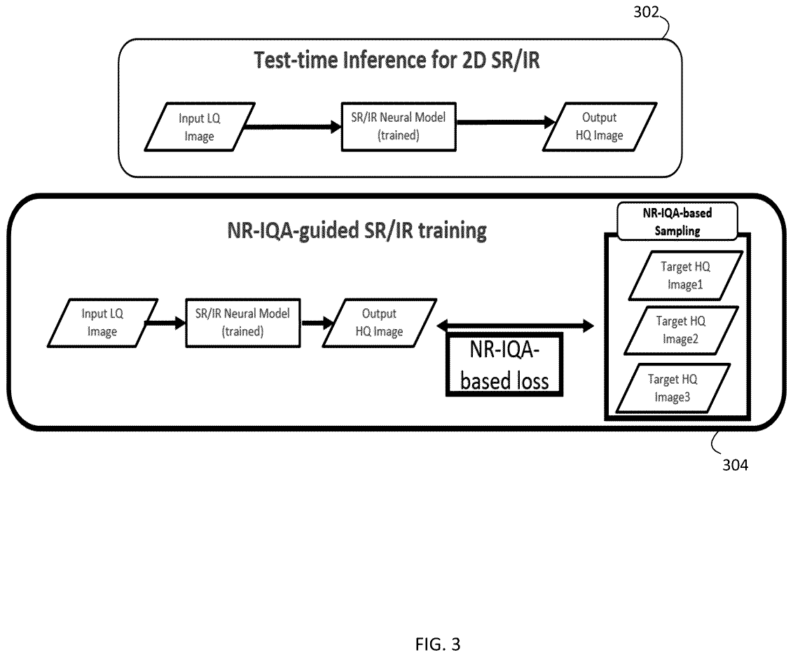

FIG. 3 illustrates an example flow chart 300 for inference and training. During an inference stage 302, an input LQ image is provided to a trained SR/IR neural model that outputs an HQ image. In a training stage 304, an input LQ image is provided to a trained SR/IR Neural Model to output an HQ image. The output HQ image is provided as input into an NR-IQ-based sampling process where an NR-IQA-based loss may be computed. In one or more examples, the SR/IR neural model in the inference stage 302 may be trained according to the operations performed in the training stage 304.

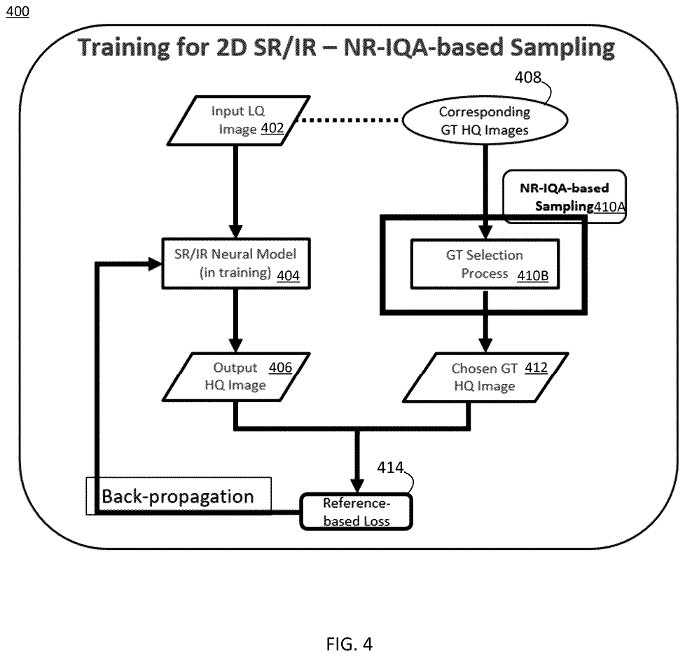

FIG. 4 illustrates an example NR-IQA based sampling process 400 for training an SR/IR neural model. The process may start in which an input LQ image 402 is input into an SR/IR Neural Model 404 that outputs an HQ image 406. One or more GT HQ images 406 are input into an NR-IQA-based sampling process 410A, which includes, in one or more examples, a GT selection process 410B. The output of the GT selection process 410B is a chosen GT HQ image 412. A reference based-loss 414 may be calculated based on the output HQ image 406 and the chosen GT HQ Image 412. The reference-based loss 414 may be back-propagated to the SR/IR Neural Model 404 to train the SR/IR Neural Model 404.

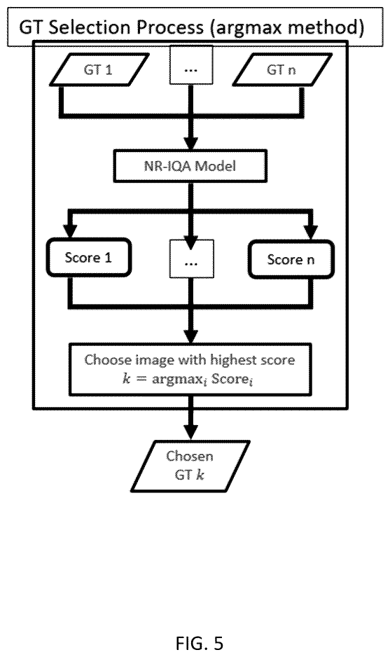

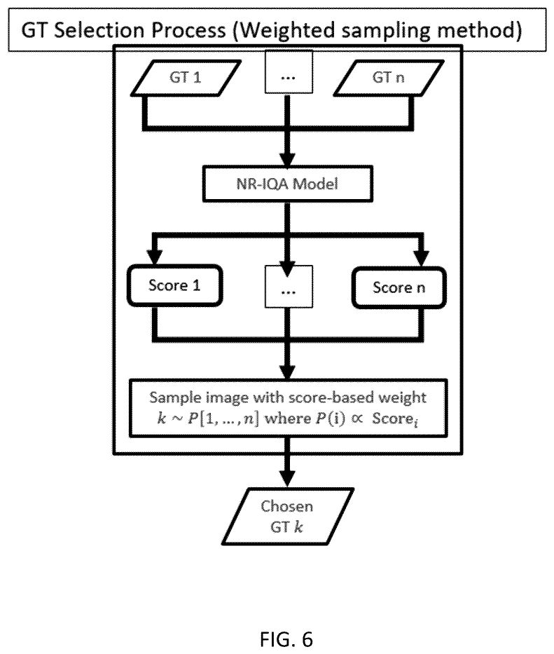

FIG. 5 illustrates an example ground-truth selection process 500 in which ground-truth images GT1-GTn are input into an NR-IQA model. The NR-IQA model outputs scores Score 1-Score n. The image with the highest score may be chosen (e.g., argmax). FIG. 6 illustrates another example ground-truth selection process 600 in which each score generated by the NR-IQA model is weighted. In one or more examples, the processes 500 and 600 may correspond to the GT selection process 410B (FIG. 4).

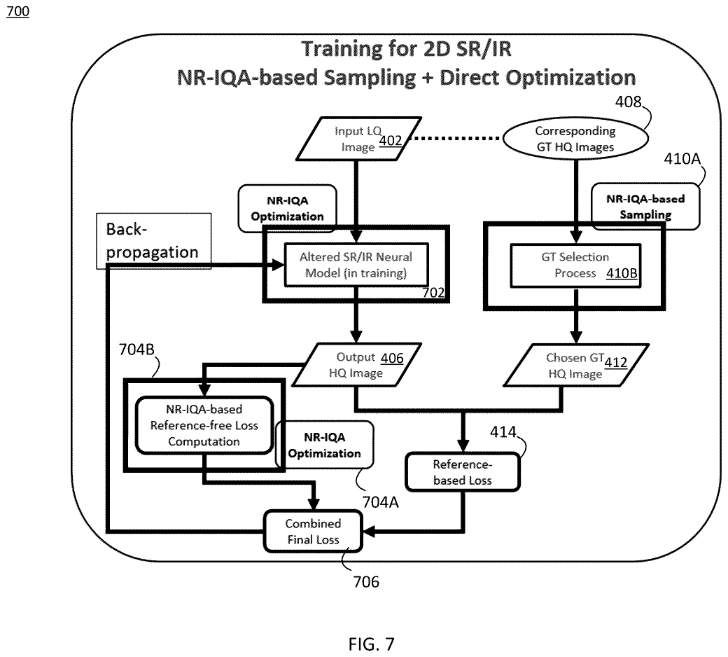

FIG. 7 illustrates an example NR-IQA based sampling and direct optimization process 700 for training an SR/IR neural model. Operations corresponding to operations performed in the process 400 (FIG. 4) use the same reference number. In the process 700 of FIG. 7, compared to the process 400 of FIG. 4, the output HQ image 406 is input into an NR-IQA optimization process 704A. The NR-IQA optimization process 704A may include an NR-IQA-based Reference-free loss computation 704B. A combined final loss 706 may be computed based on the output of the NR-IQA-based Reference-free loss computation 704B and the reference-based loss 414. The combined final loss 706 may be back-propagated to the altered SR/IR Neural Model 702.

According to one or more embodiments, given some differentiable image quality estimator, Q, an approach to improving the SR model involves including Q in the objective function. However, when Q is a neural network with many parameters, this is unlikely to be successful. In this regard, a gradient descent acts like an “adversarial attack” on Q. As understood by one of ordinary skill in the art, these “attacks” are often able to dramatically alter the output of the objective network (e.g., a classifier), while changing the optimized input in unintuitive or imperceptible ways. In the case of SR, this could conceivably manifest as artifacts that fool Q into providing a high IQA score, since NR-IQA models are known to be susceptible to attacks. Without additional regularization, NR-IQA models are susceptible to this attack. Artifacts may appear when an SR network is fine-tuned naively with Q.

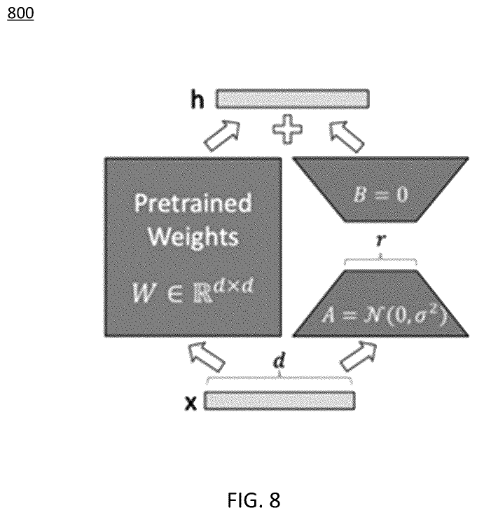

FIG. 8 illustrates a method for training part of a network using low-rank adaptation (LoRA). In one or more examples, LoRA may be used to regularize the optimization. Training may be performed as normal, but only on the LoRA weights and with an additional loss term for the NR-IQA model:

$$\tilde{ℒ} ( ϕ \vert \hat{I} , I ) = ℒ ( ϕ \vert \hat{I} , I ) - {λ}_{Q} Q ( \hat{I} ) , \qquad Eq . ( 3 )$$

where φ are the LoRA parameters, Î=f_{θ,φ}(I_{LQ}), Q is an NR-IQA model (where a higher value is better), and [symbol] is:

$$ℒ ( θ \vert \hat{I} , I ) = {λ}_{{ℓ}_{1}} {‖ I - \hat{I} ‖}_{1} + {λ}_{P} {d}_{P} ( \hat{I} , I ) + {λ}_{A} D ( \hat{I} ) . \qquad Eq . ( 4 )$$

In one or more examples, unless otherwise specified, λ_{A}=0 when fine-tuning. Architecturally, LoRA weights are inserted slightly differently depending on the model.

In one or more examples, the loss term [symbol] (φ|Î,I) computed in Eq. (3) may correspond to the combined final loss 706 (FIG. 7). In one or more examples, the term λ_{Q}Q(Î) is an example of the reference free loss 414 (FIG. 4).

In one or more examples, LoRA (a) leaves existing weights intact and (b) only alters a much smaller set of weights with limited expressive power. Using LoRA prevents artifacts that would normally be incurred by optimization of NR-IQA models. As understood by one of ordinary skill in the art, the embodiments are not limited to LoRA, and may use any suitable training method that modifies weight that are fine-tuned with regularization such as proximal optimization.

The above disclosure also encompasses the embodiments listed below:

(1) A method performed by at least one processor in an electronic apparatus includes: receiving an input image having a first resolution; inputting the input image with the first resolution into an image enhancement model to generate an output image having a second resolution higher than the first resolution; inputting a plurality of ground truth images into an image quality assessment model to generate ground truth image scores for the plurality of ground-truth images, each of the plurality of ground truth images having a third resolution; selecting a ground truth image from the plurality of ground truth images based on the generated ground truth image scores; determining a reference loss between the output image and the selected ground truth image; and training the image enhancement model based on the reference loss.

(2) The method according to feature (1), in which the selected ground truth image has a highest ground truth image score from the generated ground truth image scores.

(3) The method according to feature (1), in which the image quality assessment model is applied to a patch of each ground truth image, and in which the selected ground truth image has a patch with the highest ground truth image score from the generated ground truth image scores. a

(4) The method according to any one of features (1)-(3), further including:
inputting the output image into the image quality assessment model to obtain a reference free loss score; and determining a combined loss based on the reference free loss score and the reference loss, in which the training the image enhancement model is based on the combined loss.

(5) The method according to feature (4), further including: determining low-rank adaption (LoRA) weights for the image enhancement model, in which the determining the combined loss is further based on the LoRA weights.

(6) The method according to feature (5), in which the combined loss is sum of a difference between the reference free loss score and the reference loss.

(7) The method according to any one of features (1)-(6), in which the image enhancement model is a super-resolution/image restoration (SR/IR) neural network model.

(8) The method according to any one of features (1)-(7), in which the image quality assessment model is a No-Reference Image Quality Assessment (NR-IQA) model.

(9) A method performed by at least one processor in an electronic apparatus: receiving an input image having a first resolution; inputting the input image with the first resolution into an image enhancement model to generate an output image having a second resolution higher than the first resolution; inputting the output image into the image quality assessment model to obtain a reference free loss score; and training the image enhancement model based on the reference free loss score.

(10) The method according to feature (9), further including: determining weights that are fine-tuned with a regularization process, in which the training the image enhancement model is further based on the determined weights.

(11) The method according to feature (9) or (10), in which the image enhancement model is a super-resolution/image restoration (SR/IR) neural network model.

(12) The method according to any one of features (9)-(12), in which the image quality assessment model is an NR-IQA model.

(13) An electronic apparatus including: a memory storing one or more instructions; at least one processor operatively coupled to the memory, in which, the one or more instructions, when executed by the at least one processor, cause the electronic apparatus to: receive an input image having a first resolution, input the input image with the first resolution into an image enhancement model to generate an output image having a second resolution higher than the first resolution, input a plurality of ground truth images into an image quality assessment model to generate ground truth image scores for the plurality of ground-truth images, each of the plurality of ground truth images having a third resolution, select a ground truth image from the plurality of ground truth images based on the generated ground truth image scores, determine a reference loss between the output image and the selected ground truth image, and train the image enhancement model based on the reference loss.

(14) The electronic apparatus according to feature (13), in which the selected ground truth image has a highest ground truth image score from the generated ground truth image scores.

(15) The electronic apparatus according to feature (13) or (14), in which the image quality assessment model is applied to a patch of each ground truth image, and in which the selected ground truth image has a patch with the highest ground truth image score from the generated ground truth image scores.

(16) The electronic apparatus according to any one of features (13)-(15), in which the one or more instructions, when executed by the at least one processor, further cause the electronic apparatus to: input the output image into the image quality assessment model to obtain a reference free loss score; and determine a combined loss based on the reference free loss score and the reference loss, in which the training the image enhancement model is based on the combined loss.

(17) The electronic apparatus according to feature (16), in which the one or more instructions, when executed by the at least one processor, further cause the electronic apparatus to: determine weights that are fine-tuned with a regularization process, in which the image enhancement model is trained based on the determined weights.

(18) The electronic apparatus according to feature (16) or (17), in which the combined loss is a sum of the reference free loss score and the reference loss.

(19) The electronic apparatus according to any one of features (13)-(18), in which the image enhancement model is a super-resolution/image restoration (SR/IR) neural network model.

(20) The electronic apparatus according to any one of features (13)-(19), in which the image quality assessment model is a No-Reference Image Quality Assessment (NR-IQA) model.

What is claimed is:

1. A method performed by at least one processor in an electronic apparatus comprises:
receiving an input image having a first resolution;
inputting the input image with the first resolution into an image enhancement model to generate an output image having a second resolution higher than the first resolution;
inputting a plurality of ground truth images into an image quality assessment model to generate ground truth image scores for the plurality of ground-truth images, each of the plurality of ground truth images having a third resolution;
selecting a ground truth image from the plurality of ground truth images based on the generated ground truth image scores;
determining a reference loss between the output image and the selected ground truth image; and
training the image enhancement model based on the reference loss.

2. The method according to claim 1, wherein the selected ground truth image has a highest ground truth image score from the generated ground truth image scores.

3. The method according to claim 1, wherein the image quality assessment model is applied to a patch of each ground truth image, and
wherein the selected ground truth image has a patch with the highest ground truth image score from the generated ground truth image scores.

4. The method according to claim 1, further comprising:
inputting the output image into the image quality assessment model to obtain a reference free loss score; and
determining a combined loss based on the reference free loss score and the reference loss,
wherein the training the image enhancement model is based on the combined loss.

5. The method according to claim 4, further comprising:
determining low-rank adaption (LoRA) weights for the image enhancement model,
wherein the determining the combined loss is further based on the LoRA weights.

6. The method according to claim 5, wherein the combined loss is a sum of the reference free loss score and the reference loss.

7. The method according to claim 1, wherein the image enhancement model is a super-resolution/image restoration (SR/IR) neural network model.

8. The method according to claim 1, wherein the image quality assessment model is a No-Reference Image Quality Assessment (NR-IQA) model.

9. A method performed by at least one processor in an electronic apparatus:
receiving an input image having a first resolution;
inputting the input image with the first resolution into an image enhancement model to generate an output image having a second resolution higher than the first resolution;
inputting the output image into the image quality assessment model to obtain a reference free loss score; and
training the image enhancement model based on the reference free loss score.

10. The method according to claim 9, further comprising:
determining weights that are fine-tuned with a regularization process,
wherein the training the image enhancement model is further based on the determined weights.

11. The method according to claim 9, wherein the image enhancement model is a super-resolution/image restoration (SR/IR) neural network model.

12. The method according to claim 9, wherein the image quality assessment model is an NR-IQA model.

13. An electronic apparatus comprising:
a memory storing one or more instructions;
at least one processor operatively coupled to the memory,
wherein, the one or more instructions, when executed by the at least one processor, cause the electronic apparatus to:
receive an input image having a first resolution,
input the input image with the first resolution into an image enhancement model to generate an output image having a second resolution higher than the first resolution,
input a plurality of ground truth images into an image quality assessment model to generate ground truth image scores for the plurality of ground-truth images, each of the plurality of ground truth images having a third resolution,
select a ground truth image from the plurality of ground truth images based on the generated ground truth image scores,
determine a reference loss between the output image and the selected ground truth image, and
train the image enhancement model based on the reference loss.

14. The electronic apparatus according to claim 13, wherein the selected ground truth image has a highest ground truth image score from the generated ground truth image scores.

15. The electronic apparatus according to claim 13, wherein the image quality assessment model is applied to a patch of each ground truth image, and
wherein the selected ground truth image has a patch with the highest ground truth image score from the generated ground truth image scores.

16. The electronic apparatus according to claim 13, wherein the one or more instructions, when executed by the at least one processor, further cause the electronic apparatus to:
input the output image into the image quality assessment model to obtain a reference free loss score; and
determine a combined loss based on the reference free loss score and the reference loss,
wherein the training the image enhancement model is based on the combined loss.

17. The electronic apparatus according to claim 16, wherein the one or more instructions, when executed by the at least one processor, further cause the electronic apparatus to:
determine weights that are fine-tuned with a regularization process,
wherein the image enhancement model is trained based on the determined weights.

18. The electronic apparatus according to claim 16, wherein the combined loss is a sum of the reference free loss score and the reference loss.

19. The electronic apparatus according to claim 13, wherein the image enhancement model is a super-resolution/image restoration (SR/IR) neural network model.

20. The electronic apparatus according to claim 13, wherein the image quality assessment model is a No-Reference Image Quality Assessment (NR-IQA) model.
